(19) United States
(12) Patent Application Publication
(10) Pub. No.: US 2015/0220106 A1
(43) Pub. Date: Aug. 6, 2015

(54) Connection Box with Integrated Multi-port Connectors for Laptop and Mobile Devices

(71) Applicants: Ludi Lai, Baltimore, MD (US); Caleb Zhang, Baltimore, MD (US)

(72) Inventors: Ludi Lai, Baltimore, MD (US); Caleb Zhang, Baltimore, MD (US)

(21) Appl. No.: 14/173,720

(22) Filed: Feb. 5, 2014

(51) Int. Cl. G06F 1/16

(52) U.S. Cl. CPC G06F 1/16

(57) ABSTRACT

A connection box with novel integrated multi-port connectors provides a convenient and low cost method to fast connect/disconnect multiple external devices to/from the laptop or mobile devices simultaneously. It also allows fast switching connection of the external devices among connected desktop, laptops and mobile devices.

### BACKGROUND OF THE INVENTION

Today laptop and mobile devices are widely used in many fields as the most popular working tools and household appliances. Their mobility, usually evaluated by the size and weight, is one of the most important specifications in both the industry and marketplace. To reduce every single millimeter or gram of the products numerous efforts have been made and countless new technologies have been invented. However, in many cases compromises still have to be made on user experiences. For example, to fit in a limited space most laptops abandon the numeric keypad from the standard 104-key keyboard, and use touchpad or track ball to replace traditional mouse. In addition, their screens, build-in speakers and cameras are usually not as competitive as the external ones.

Therefore, people often choose to connect the laptop or even mobile devices to the external devices for the best of performances if possible. However, it is not easy to connect all the external devices to the laptop one by one each time when people use them, since each external device has its own connector and these connectors might come in a large variety of types. A monitor may use HDMI or thunderbolt connector; mouse and keyboard plug to USB or PS2 port; speaker and microphone are usually connected via TRS Interface, and there are even more if one wants to use Ethernet network, printer, scanner, camera, blue ray driver etc. How to organize these wires and connectors is also a big problem.

Moreover there is no easy way to switch the external devices among desktop, laptops and mobile devices. Many people need to use more than one computers in their workspaces. Switching computers usually means unplugging all the wires from one and plugging to another. It will be more difficult when the desktop is involved because they are normally placed under the table and most of their connectors are at the back of the machines.

### SUMMARY OF THE INVENTION

Accordingly, it is our objective to provide an easy method to connect multiple external devices to laptop or mobile devices, which also allows users to fast switch the connection of external devices among desktop, laptops and mobile devices.

To achieve the aforementioned objective, the present invention provides a connection box using a set of the standard ports to connect to the external devices that one desires to use in their workspace. The ports should support the commonly used external devices including keyboards, speakers, monitors, printers, scanners etc.

The connection box also contains another set of standard ports and an integrated multiple-port connector, which can integrate all the signals from/to external devices and send/receive them together. With the associated cables, these standard ports and the integrated multiple-port connector provide two easy ways to connect the connection box to a desktop and the communication between the external devices and the desktop can be bridged by the connection box.

To fast connect/switch the external devices plugged into the connection box to the laptops or mobile devices, the connection box also has additional USB connectors and integrated multiple-port connectors for one to choose. Similar to above, once a laptop or mobile device is connected to the connection box via any one of these connectors, the connection box can establish the connection between it and the external devices

Additionally, the connection box has a switch operable to select the communication to the external devices among the desktop, laptops and mobile devices. The switch can be configured by manipulation of a button on the connection box, or use of a software on the connected desktop, laptops, or mobile devices. The switch can also be set in many statuses, such as “connect external devices to desktop”, “connect external devices to the first (second, third . . . ) laptop or mobile device”, or “automatically connect external devices to the laptop or mobile device when it is connected and automatically connect external devices to the others when a laptop or mobile device is disconnected”. Furthermore, the software can modify the connection of each individual external device connected to the connection box, allowing some external devices to be connected to the desktop while the others are connected to the laptops or mobile devices.

### BRIEF DESCRIPTION OF THE DRAWINGS

FIG. 1 is a schematic diagram of an example system operating in accordance with present principles.

FIG. 2 is a schematic diagram of an example connection box with integrated multi-port connectors.

FIG. 3 is a block diagram of an example switch operable to select communication to external devices among the desktop, laptops and mobile devices.

### DETAILED DESCRIPTION

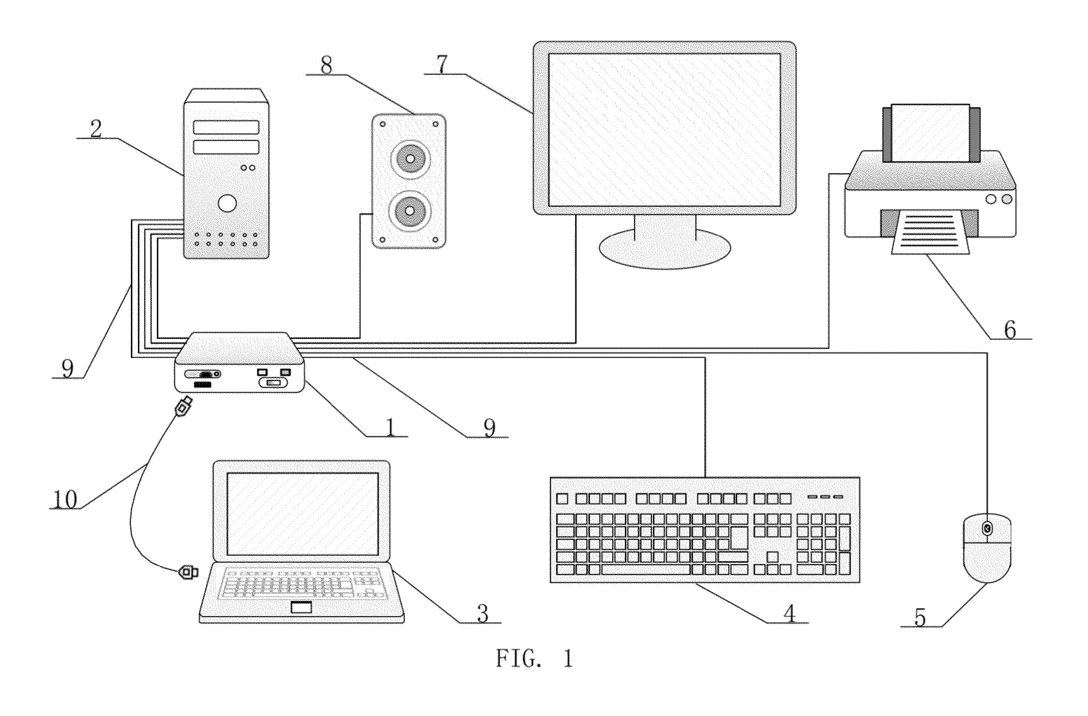

Referring initially to FIG. 1, a system includes a connection box 1, a desktop 2, a laptop or mobile device 3 (in the real system more than one laptops or mobile devices can he supported, for simplification purposes, only one is plotted in FIG. 1), possible external devices such as a keyboard 4, a mouse 5, a printer 6, a monitor 7 and a speaker 8, associated connection cables for external devices 9, and an integrated multi-port connector cable or a USB cable 10.

The external devices 4-8 are connected to the desktop 2 via the connection box 1 with the associated cables 9. Once the connection box 1, the desktop 2 and the associated cables 9 are set up, they can be placed under the computer desk to maintain an organized workspace. When the user would like to use the external devices 4-8 on the laptop or mobile device 3, they can connect it to the connection box 1 via the integrated multi-port connector cable or USB cable 10, and the connection box 1 can switch the communication to external devices 4-8 between the desktop 2 and the laptop or mobile device 3 with plug and play function.

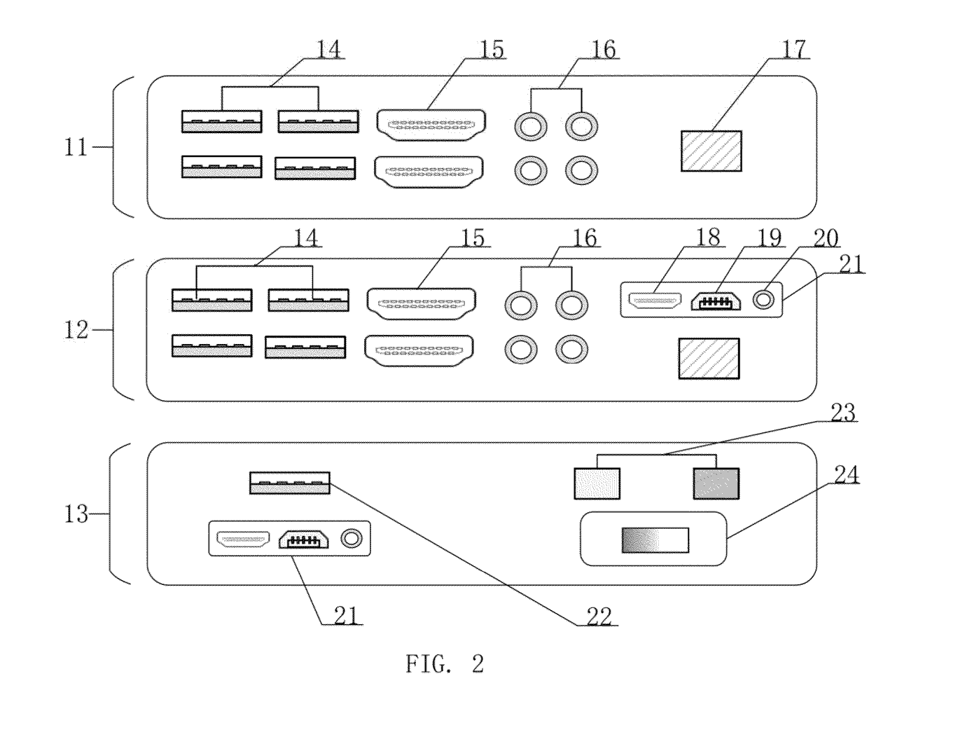

FIG. 2 illustrates the left panel 11, the right panel 12 and the front panel 13 of the connection box 1. The left panel 11 is designed for external devices 4-8 to plug into, it contains all of the most frequently used ports such as USB 14, HDMI 15, audio 16 and may also include other ports 17 such as Ethernet PS2, VGA, Thunderbolt, etc. which can be selected based on user system requirements.

The right panel 12 is used to communicate with the desktop 2, it has a similar structure 14-17 as the left panel 11 except an additional integrated multi-port connector 21. The integrated multi-port connector 21 may include an HDMI port 18, a USB port 19, an audio port 20, and maybe other additional ports if necessary. The types and numbers of the ports 18-20 can be modified depending on the connectors of the external devices 4-8 that the user wants to use in the system, but generally they should he in accordance with their industry standards and in the micro types to minimize the overall size of the integrated multi-port connector 21. To connect the desktop 2 to the connection box 1, the user can choose the aforementioned traditional ports 14-17 on the left hand side of the right panel, or use the integrated multi-port connector 21 if the desktop 2 has the same integrated multi-port connector 21 built in.

The front panel 13 has two functions including providing connectors for laptops or mobile devices 3 and controlling the connection of the system. It contains an integrated multi-port connector 21, a USB connector 22 (in the real system both types of connectors can be more than one to support more laptops or mobile devices. For simplification purposes, only one is plotted in FIG. 2), LED indicators 23, and a switch button 24.

Similar to the right panel 12, the front panel allows the user to use either the integrated multi-port connector 21 or the USB connector 22 to connect a laptop or mobile device 3 to the connection box 1. If the USB connector 22 is in use, the connection box 1 can work as an adapter for the external devices that use non-USB connector, converting all the possible non-USB signals from external devices to USB signals under current technologies, and sends/receives all the USB signals (including intrinsic and converted USB signals) via one USB connector 20 to the laptop or mobile device 3. However, in this way the laptop or mobile device 3 connected to the connection box 1 can only access the external devices using USB signals or whose signals can be converted to USB signals.

When the external devices 4-8, the desktop 2 and the laptop or mobile device 3 are connected to the connection box 1, the user can use it to bridge the connections of external devices 4-8 to the desktop 2, laptop or mobile device as they desire. These connections can be monitored and managed by the LED indicators 23 and the switch button 24 on the front panel. The LED indicators 23 show whether the desktop, laptop or mobile device 3 is using any of the external devices 4-8. Each LED indicator 23 represents one desktop, laptop or mobile device, respectively. Therefore the number of LED indicators 23 should be consistent with the maximum number of desktops, laptops and mobile devices that the connection box 1 can support. More than one LED indicators can be on at the same time, for it is not necessary only one desktop, laptop or mobile device has the connection to all external devices 4-8. The switch button 24 is used to manually select among desktop, laptops and mobile devices to have the communication to the external devices 4-8.

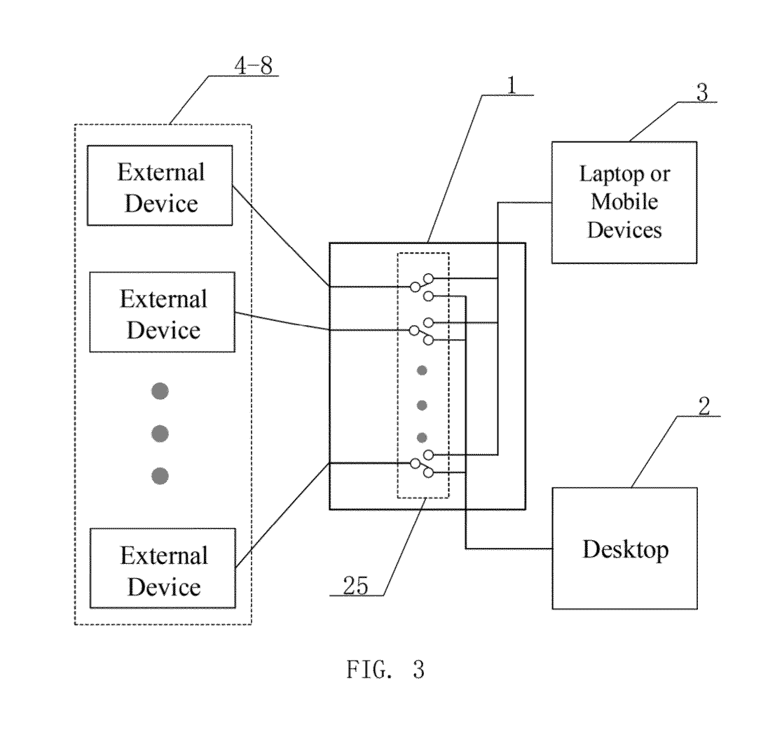

FIG. 3 shows that the connection box 1 contains a switch 25 selecting the connection to external devices 4-8 between the desktop 2 and the laptop or mobile device 3, the switch 25 can be manually triggered by the switch button 24 on the front panel 11 of the connection box 1, or by the software installed on the desktop 2, the laptop or mobile device 3 connected to the connection box 1. The switch 25 can be set in many statuses, such as “connect all external devices to desktop”, “connect all external devices to the first (second, third, . . . ) laptop or mobile device” (For simplification purposes, only one is plotted in FIG. 3), the switch 25 also allows the connection box 1 to automatically sense the engagement of a desktop, laptop or mobile device and establish the connections accordingly as configured, or automatically sense the disconnection of a desktop, laptop or mobile device and concede the connections to others as configured. With the software, the switch 25 can even modify the connection of every single external device 4-8, allowing the connection box 1 to simultaneously maintain the connection of some external devices 4-8 to the desktop 2 and the others to the laptop or mobile devices 3.

1. A system comprising:
A desktop, laptops or mobile devices with associated connection cables;
Connection cables for the integrated multi-port connector
A connection box with three sets of connection ports. The first set includes the most frequently used ports used to connect the external devices. The second set contains similar ports as the first set and an integrated multi-port connector, to desktop can be connected through them. The third set has the integrated multi-port connectors and USB ports to communicate with laptops or mobile devices.
A switch operable to select the communication to the external devices among the desktop, laptops and mobile devices. The switch can be configured in man statues including connecting the external devices to the desktop, connecting the external devices to the desired laptops or mobile devices, or automatically connecting the external devices to the newly engaged desktop, laptop or mobile device, or switching the connection of external devices from the newly disconnected desktop, laptop or mobile device to the others. The switch also has more customizable configurations which can be manipulated by the switch button on the connection box, or modified by the software on the connected desktop, laptops or mobile devices to set the connection of individual external device.

2. The system of claim 1, wherein the connection box is designed to connect to one or more keyboards, mice, speakers, monitors, and other external devices.

3. The system of claim 1, wherein the connection box is designed to connect to one or more desktop, laptops and mobile devices.

4. The system of claim 1, wherein the connection box can fast connect/disconnect multiple external devices to desktop, laptops or mobile devices simultaneously.

5. The system of claim 1, wherein the connection box can fast switch connection of the external devices among desktop, laptops and mobile devices.

6. The system of claim 1, wherein the connection box has the plug and play function, and supports the plug and play functions of the external devices connected to it.

7. The system of claim 1, wherein the connection box can adapt all the possible non-USB ports used by external devices to USB ports under current technology.

8. The system of claim 1, wherein the connection box is designed to be capable of automatically detecting the connection/disconnection of external devices.

9. The system of claim 1, wherein the connection box can sense the engagement/disconnection of desktop, laptop or mobile device, and automatically establish the new connection from external devices to the desired desktop, laptops or mobile devices as configured.

10. The system of claim 1, wherein the switch can be configured by manipulating a switch button on the connection box, or by using the software presentable on the connected desktop, laptops or mobile devices.

11. An integrated multi-port connector comprising USB, video, audio and other ports.

12. The integrated multi-port connector of claim 11, wherein the integrated multi-port connector can be used on the connection box, desktop, laptop or mobile devices.

13. The integrated multi-port connector of claim 11, wherein the number and combination of ports can be customized to meet different user requirements. For example, it uses HDMI for PC users and Thunderbolt for Mac users.

14. The integrated multi-port connector of claim 1, wherein all the ports use current industry standards and can be updated with new standards.

15. A cable using integrated multi-port connectors on one or both ends.

16. A method comprising
Fast connecting disconnecting multiple external devices to desktop, laptops or mobile devices simultaneously.
Fast switching connections of the external devices among desktop, laptops and mobile devices
Configuring the switch operable to select the communication to the external devices among, desktop, laptops and mobile devices manually or with the software on the connected desktop, laptops or mobile devices.

17. The method of claim 16, wherein the newly connected desktop, laptop or mobile device, can automatically acquire the communication to the desired external devices.

18. The method of claim 16, wherein the newly disconnected desktop, laptop or mobile device can automatically concede the connection of external devices to other connected desktop, laptops or mobile devices.
